(19) United States
(12) Patent Application Publication
(10) Pub. No.: US 2018/0075423 A1
(43) Pub. Date: Mar. 15, 2018

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Osamu YAMAGUCHI, Yokohama (JP); Tomoyuki SHIBATA, Kawasaki (JP)

(73) Assignee: KABUSHIKI KAISHA TOSHIBA, Tokyo (JP)

(21) Appl. No.: 15/445,559

(22) Filed: Feb. 28, 2017

(30) Foreign Application Priority Data
Sep. 14, 2016 (JP) 2016-179875

(51) Int. Cl. G06Q 20/10; G06T 7/70

(52) U.S. Cl. CPC G06Q 20/1085; G06T 7/70

(57) ABSTRACT

An information processing device according to an embodiment includes a determination unit and an output control unit. The determination unit is configured to determine an output position of output information about a state of a line, in real space, on the basis of structural information representing a structure of the line formed by objects included in an object image. The output control unit is configured to control output of the output information to the output position.

### CROSS-REFERENCE TO RELATED APPLICATIONS

This application is based upon and claims the benefit of priority from Japanese Patent Application No. 2016-179875, filed on Sep. 14, 2016; the entire contents of which are incorporated herein by reference.

### FIELD

Embodiments described herein relate generally to an information processing device, an information processing method, and a computer program product.

### BACKGROUND

Systems are known which display a waiting time in a line of people. For example, a system is disclosed which displays a waiting time in a line of people in front of a machine, on a display provided in the machine including an automated trading machine such as an automated teller machine (ATM) or a cash dispenser (CD), or an automated ticketing machine.

Here, the shape, position, or the like of a line of objects, such as people, changes with time. However, such a conventional system displays the waiting time on a display of a machine arranged at the head of a line. Therefore, depending on a situation of the line, people in the line are sometimes inhibited from understanding the waiting time or the like. Thus, information has not been appropriately provided according to the situation of the line.

### BRIEF DESCRIPTION OF THE DRAWINGS

FIG. 1 is a diagram illustrating an example of an information processing system;

FIG. 2 is a schematic diagram illustrating an example of the information processing system;

FIGS. 3A and 3B are explanatory diagrams of identification of structural information;

FIGS. 3A to 4F is an explanatory diagram of the identification of structural information;

FIG. 5 is a schematic diagram illustrating an example of a data configuration of a display type management DB;

FIGS. 6A to 6E are schematic diagrams illustrating examples of display types;

FIGS. 7A to 7F are schematic diagrams illustrating examples of display types;

FIG. 8 is a schematic diagram illustrating an example of output information projected in real space;

FIGS. 9A to 9D are schematic diagrams illustrating examples of update or change of a projection screen;

FIG. 10 is a flowchart illustrating an example of a procedure of information processing;

FIG. 11 is a flowchart illustrating an example of a procedure of structural information identification processing;

FIG. 12 is a flowchart illustrating an example of a procedure of output position determination and output processing and update and change processing;

FIG. 13 is a schematic diagram illustrating a state in which a display screen is displayed in real space;

FIG. 14 is a schematic diagram illustrating an environment in which a plurality of displays is arranged in real space; and

FIG. 15 is a diagram of a hardware configuration.

### DETAILED DESCRIPTION

An information processing device according to an embodiment includes a determination unit and an output control unit. The determination unit is configured to determine an output position in real space of output information about a state of a line based on the structural information representing a structure of the line formed by objects included in an object image. The output control unit is configured to control output of the output information to the output position.

An information processing device, an information processing method, and a computer program product will be described below in detail with reference to the accompanying drawings.

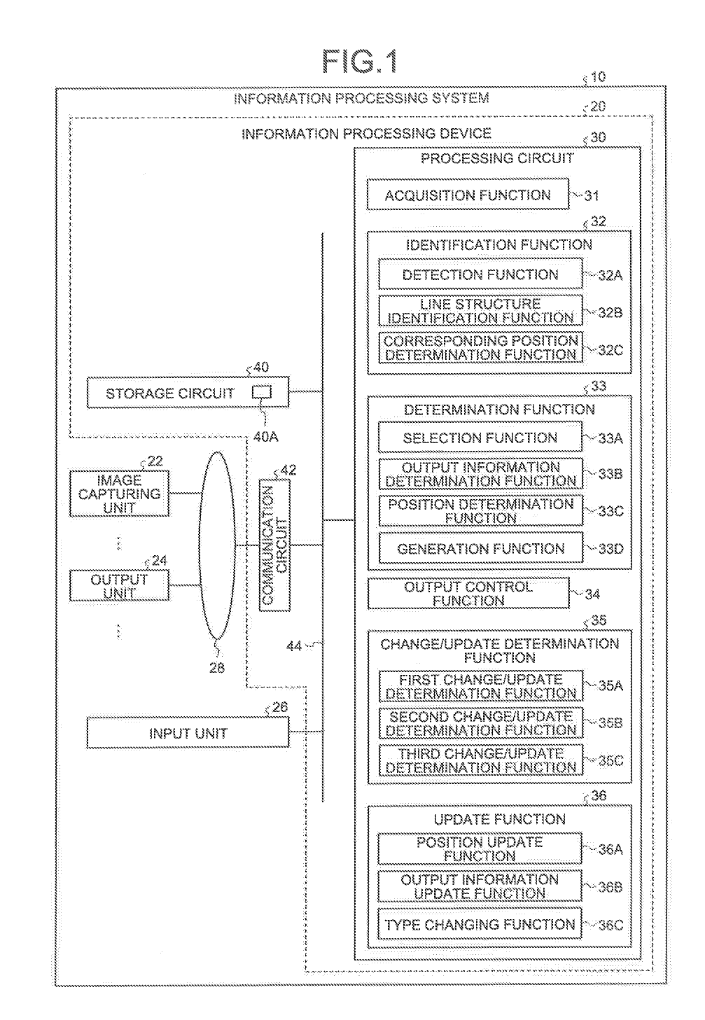

FIG. 1 is a diagram illustrating an example of an information processing system 10 according to the present embodiment.

The information processing system 10 includes the information processing device 20, an image capturing unit 22, an output unit 24, and an input unit 26. The image capturing unit 22 and the output unit 24 are connected to the information processing device 20 through a network 28. The network 28 includes a local area network (LAN) or the Internet. The input unit 26 and the information processing device 20 are connected through a control bus 44.

The image capturing unit 22 is an example of an image capturing unit. The image capturing unit 22 obtains a captured image in image capture. The image capturing unit 22 includes for example an image capture device to obtain two-dimensional captured-image data in image capture or a distance sensor (millimeter-wave radar, laser sensor, range and image sensor). The laser sensor includes for example a two-dimensional laser imaging detection and ranging (LIDAR) sensor or a three-dimensional LIDAR sensor.

The captured image is captured-image data obtained in image capture (hereinafter, sometimes simply referred to as captured image). The captured image is digital image data having a pixel value defined for each pixel, a depth map representing a distance from the image capturing unit 22 for each pixel, or the like.

In the present embodiment, the information processing system 10 includes one or more image capturing units 22. When the information processing system 10 includes a plurality of image capturing units 22, at least one or the image capturing units 22 may be arranged at a position different from those of remaining image capturing units 22. Furthermore, when the information processing system 10 includes the image capturing units 22, the image capturing units 22 may be arranged at positions where they have angles of view overlapping each other at least partially, or may be arranged at positions where they have different angles of view.

In the present embodiment, the image capturing unit 22 captures an image of an object positioned within the angle of view of the image capturing unit 22 to obtain an object image including the object.

The object represents a subject, an image of which is captured by the image capturing unit 22. Any object may be employed, as long as a plurality of the objects can form a line. The object may be any of a moving object and a non-moving object.

The moving object represents a movable object. The moving object may be any of a movable living object and a movable non-living object. The movable living object includes for example a human or an animal. The movable non-living object includes for example a vehicle (motorcycle, four wheel motor vehicle, bicycle), a dolly, a robot, a ship, a flying object (airplane, drone, or the like).

The non-moving object represents a non-movable object. The non-moving object may be any of a non-movable living object and a non-movable non-living object. The non-movable living object includes for example a plant such as a tree or a flower. The non-movable non-living object includes for example a stationary article.

For example, in the present embodiment, the object is described as a person.

The output unit 24 outputs output information. The output information is information output outside the information processing device 20. The output information is information about a line of the objects (detailed description will be made later).

In the present embodiment, the output unit 24 is a projector projecting a screen including the output information, or a display displaying thereon a screen lading the output information.

For example, in the present embodiment, the output unit 24 is described as the projector.

Note that, the information processing system 10 includes one or more output units 24. The output unit 24 is arranged at a position corresponding to at least one image capturing unit 22. Specifically, the cutout unit 24 is arranged at a position where the output information described later can be output toward an area including the angle of view of the at least one image capturing unit 22, in real space.

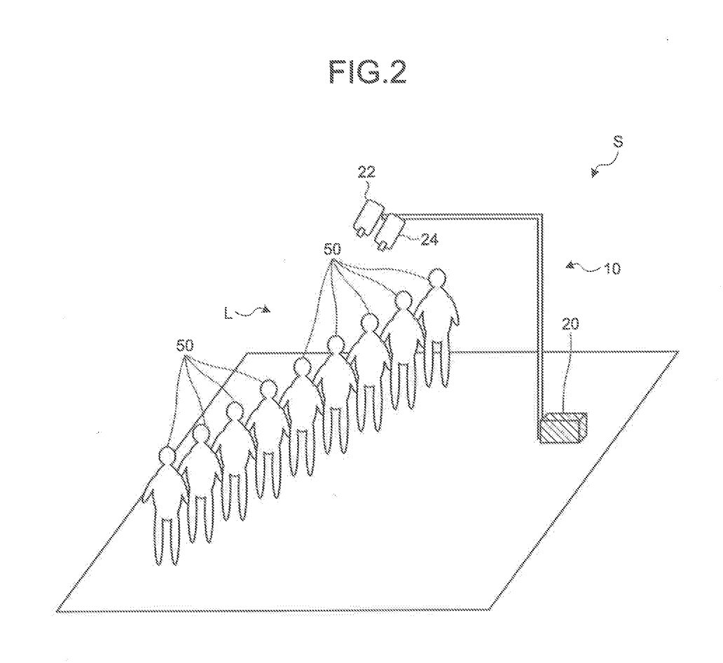

FIG. 2 is a schematic diagram illustrating an example of the information processing system 10 arranged in real space S. The image capturing unit 22 captures an image of an object 50 in real space S. The output unit 24 is arranged at a position where the output information can be output toward the area including the angle of view of the image capturing unit 22.

In the present embodiment, a description is given of the object 50 in real space S, where a plurality of the objects 50 is aligned (or arranged) into a line L. The image capturing unit 22 captures an image of the area including the line L of the objects 50 in real space S, and obtains an object image. Furthermore, the output unit 24 outputs the output information, about a situation of the line L, to an output position in real space S (detailed description will be made later).

Returning to FIG. 1, further description will be given. The input unit 26 receives input of various instructions or information from a user. The input unit 26 is for example a pointing device such as a mouse or a trackball, or an input device such as a keyboard. Furthermore, the input unit 26 may be an input function in a touch, panel integrally provided on a display.

Next, the information processing device 20 will be described. The information processing device 20 outputs the output information about a situation of the line of the objects, from the output unit 24.

The information processing device 20 includes a storage circuit 40, a processing circuit 30, and a communication circuit 42. The storage circuit 40, the processing circuit 30, and the communication circuit 42 are connected through the bus 44. In addition, the communication circuit 42 is connected with the network 28.

Note that at least one of the image capturing unit 22, the output unit 24, the input unit 25, and the storage circuit 40 is preferably connected to the processing circuit 30 in a wired or wireless manner. Furthermore, at least one of the image capturing units 22 or at least one of the output units 24 is preferably connected to the processing circuit 30 in a wired or wireless manner. Furthermore, at least one of the storage circuit 40 and the processing circuit 30 may be mounted to a cloud server performing processing in the cloud.

The storage circuit 40 stores various data. The storage circuit 40 is an example of a memory. In the present embodiment, the storage circuit 40 previously stores a display type management DB 40A (detailed description will be made later). For example, the storage circuit 40 is a semiconductor memory device such as a random access memory (RAM), a flash memory, a hard disk, an optical disk, or the like. Note that the storage circuit 40 may be a storage device provided outside the information processing device 20. Furthermore, the storage circuit 40 may be a storage medium. Specifically, the storage medium may store or temporarily store a program or various kinds of information downloaded through a local area network (LAN) or the Internet. Furthermore, the storage circuit 40 may include a plurality of storage mediums.

Next, the processing circuit 30 will be described. The processing circuit 30 includes an acquisition function 31, an identification function 32, a determination function 33, an output control function 34, a change/update determination function 35, and an update function 36. The processing circuit 30 is an example of processing circuitry.

Each of the processing functions in the processing circuit 30 is stored in the storage circuit 40, in the form of a program executable by a computer. The processing circuit 30 is a processor reading each program from the storage circuit 40, and executing the program to achieve a function corresponding to the program.

The processing circuit 30 reading each program has each function illustrated in the processing circuit 30 of FIG. 1. In FIG. 1, a description will be given of the acquisition function 31, the identification function 32, the determination function 33, the output control function 34, the change/update determination function 35, and the update function 36, which are achieved by a single processing circuit 30.

Note that the processing circuit 30 may be constituted by combining a plurality of independent processors achieving the functions, respectively. In this configuration, the processors execute the programs respectively to achieve the functions. Furthermore, the processing functions may be configured as programs so that one processing circuit executes the programs, or a specific function may be implemented in an independent dedicated program execution circuit.

Note that, the term “processor” used in the present embodiment represents for example, a circuit such as a central processing unit (CPU), a graphical processing unit (GPU), an application specific integrated circuit (ASIC), or a programmable logic device (e.g., simple programmable logic device (SPLD), complex programmable logic device (CPLD), and field programmable gate array (FPGA)).

The processor reads a program stored in the storage circuit 40 and executes the program to achieve a function. Note that the programs may be directly incorporated in a circuit of the processor, instead of being stored in the storage circuit 40. In this configuration, the processor reads a program incorporated in the circuit, and executes the program to achieve a function.

The acquisition function 31 acquires an object image. In the present embodiment, the acquisition function 31 acquires the object image from the image capturing unit 22. In the present embodiment, the image capturing unit 22 sequentially outputs the object images obtained in continuous image capture, to the processing circuit 30. Therefore, the acquisition function 31 sequentially acquires the object images from the image capturing unit 22. The acquisition function 31 outputs an acquired object image to the identification function 32, each time when the object image is acquired.

The identification function 32 is an example of an identification unit. The identification function 32 identifies structural information based on the object image.

The structural information is information representing a structure of the line L of the objects 50, included in the object image.

Specifically, the structural information represents at least one of a shape of the line L, a start point position of the line L, and an end point position of the line L. In the present embodiment, the structural information represents the shape of the line L, the number of the objects 50 in the line L, a position of each object 50 in the line L, the start point position of the line L, the end point position of the line L, a line area of the line L, a peripheral area of the line L, and an attribute of each object 50.

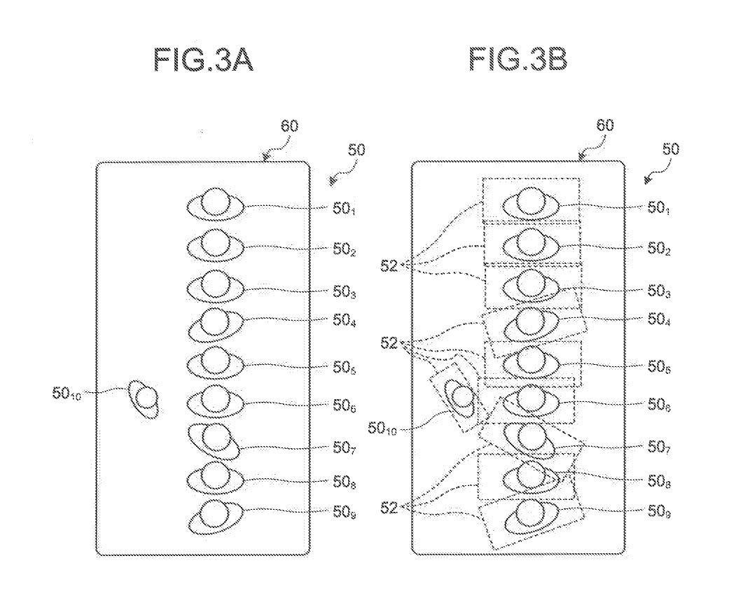

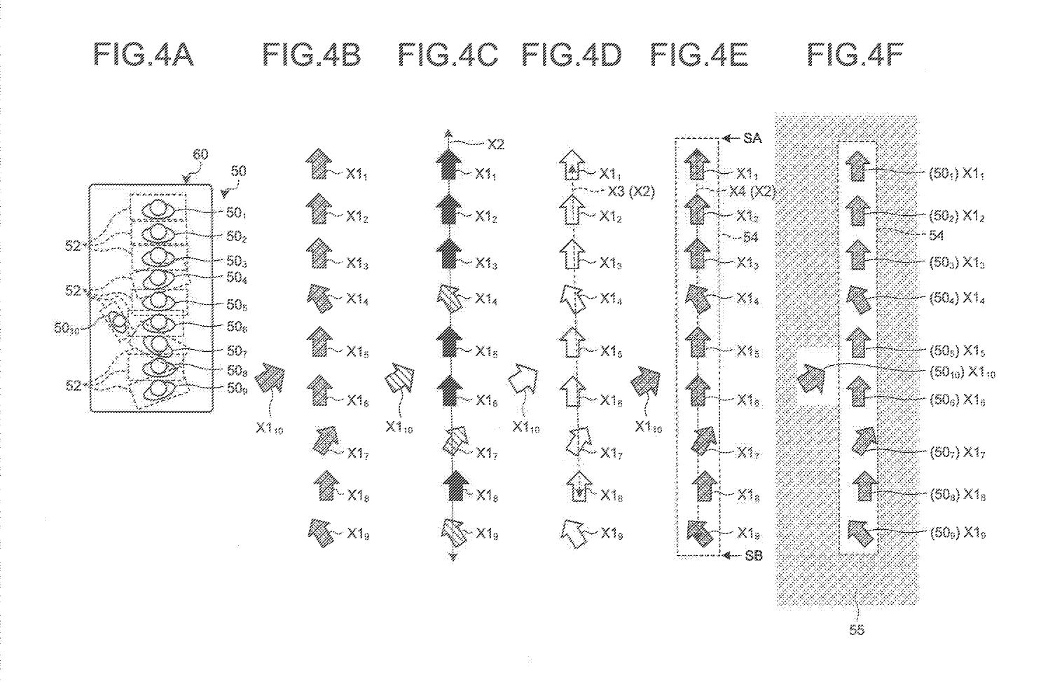

In the present embodiment, the identification function 32 includes a detection function 32A, a line structure identification function 32B, and a corresponding position determination function 32C. FIGS. 3A, 3B and 4 are explanatory diagrams of identification of the structural information.

The detection function 32A identifies an object 50 included in the object image 60. For example, it is assumed that the object image acquired by the acquisition function 31 is an object image 60 illustrated in FIG. 3A. Note that the object image 60 is a captured image obtained by capturing a person as the object 50 from above. Thus, the shoulder and head of the person is captured in the object image 60. Furthermore, as illustrated in FIG. 3A, it is assumed that the object image 60 includes a plurality of the objects 50 (objects 50₁ to 50₁₀).

The detection function 32A identifies an area (referred to as object area 52 in description) occupied by each of the objects 50 (objects 50₁ to 50₁₀) included in the object image 60.

The detection function 32A preferably identifies the object area 52 of each of the objects 50 included in the object image 60, using a known method. For example, the detection function 32A uses a known template matching method or the like to detect a person as the object 50.

Note that a template used for the template matching is preferably prepared in advance according to the kind of the object 50 to be processed. For example, a template is prepared in advance to detect a person as the object 50. Note that, from the viewpoint of detection precision, the template matching may use machine learning to extract features representing a person in an image area to generate learning data.

FIG. 3B illustrates an example of the object areas 52 of the objects 50 detected from the object image 60. For example, the detection function 32A identifies the object area 52 occupied by each object 50 in the object image 60.

At this time, the detection function 32A may further detect the attribute, such as a direction, a size, or a kind, of the object 50 included in the object image 60. The direction of the object 50 represents a direction in which the object 50 faces. For example, when the object 50 is a person, the direction of the object 50 represents a direction of the face of the object 50. For example, when the object 50 is a person, the kind of the object 50 represents gender, estimated age (adult, child, or the like), or the like. For example, in this configuration, the detection function 32A preferably prepares several kinds of templates in advance to acquire the attributes such as the direction and the size of the object 50. Furthermore, for example, the detection function 32A may use an identification device for identification of the attribute of each object 50.

In the present embodiment, a description is given of the detection function 32A which detects the object area 52 of each of the objects 50 included in the object image 60, and the attribute of each object 50. Specifically, the detection function 32A detects a position (Xd, Yd) of each object area 52, a size (Wd, Hd) of the object area 52; a direction (θd) of the object area 52, and the like in the object image 60. The position of the object area 52 employs, for example, a position of the centroid of the object area 52 in the object image 60.

Note that when the object image 60 is a depth image, the detection function 32A can also detect height information as an attribute of each object area 52. For example, when the object 50 is a person, the height information can be used for a person's height, for detection of the gender or age.

Next, the line structure identification function 32B will be described. The line structure identification function 32B identifies the structural information about the line L of the objects 50 based on the objects 50 detected by the detection function 32A (i.e., object areas 52 and attributes).

FIGS. 4A to 4F are explanatory diagrams of an example of a process of identifying the structural information. As illustrated in FIG. 4A, for example, it is assumed that the detection function 32A detects the objects 50 included in the object image 60 (object areas 52 and attributes).

In this configuration, the line structure identification function 32B performs the following processing to detect the structural information about the line L.

FIGS. 4B to 4F illustrate positions and directions of the objects 50 in the object image 60 (see FIG. 4A), which are indicated by arrows X1. In FIGS. 4A to 4F, arrows X1₁ to X1₁₀ indicate directions of the objects 50₁ to 50₁₀, respectively.

First of all, the line structure identification function 32B reads the positions of the objects 50 detected by the detection function 32A, and the directions of the object areas 52 included in the attributes of the objects 50 included in the object image 60 (arrows X1₁ to X1₁₀) (see FIG. 4B).

Then, the line structure identification function 32B identifies a line direction of the line L of the objects 50 (objects 50₁ to 50₁₀) based on the directions (arrows X1₁ to X1₁₀) of the objects 50 (objects 50₁ to 50₁₀) included in the object image 60. The line structure identification function 32B identifies an direction indicated by maximum objects 50 in the object image 60 as a line direction X2 (see FIG. 4C).

For estimation of the line direction X2, a known method is preferably employed. For example, the line structure identification function 32B quantizes the directions (arrows X₁ to X1₁₀) of the objects 50 (objects 50₁ to 50₁₀) included in the object image 60 in eight directions. Then, the direction indicated by the maximum frequency of quantized directions of objects 50 is identified as the line direction X2.

In the example of FIGS. 4A to 4F, the line structure identification function 32B identifies a direction of directions (arrows X1₁ to X1₃ arrows X1₅ and X1₆; arrow X1₈) corresponding to objects 50₁ to 50₃, the objects 50₅ and 50₆, and the object 50₈, as the line direction X2 (see FIG. 4C).

Note that the line structure identification function 32B may form a histogram of the directions (arrows X1₁ to X1₁₀) of the objects 50 (objects 50₁ to 50₁₀) included in the object image 60. In addition, the line structure identification function 32B may identify a most frequent direction in the histogram, as the line direction X2.

Next, the line structure identification function 32B identifies an object 50 which is located out of the identified line direction X2, from the objects 50 included in the object image 60.

Specifically, the line structure identification function 32B identifies, from the objects 50 (objects 50₁ to 50₁₀) included in the object image 60, positions of objects 50 (objects 50₁ to 50₃, objects 50₅ and 50₆, object 50₈) corresponding to the directions (arrow X1₂ to X1₃, arrows X1₅ and X1₆, arrow X1₈) coinciding with the line direction X2. Note that the line structure identification function 32B uses the position of the object area 52 detected by the detection function 32A, as the position of the object 50.

Then, the line structure identification function 32B applies a function representing a line X3 (e.g., straight line) passing through the objects 50 at the identified positions, to the objects 50 at the identified positions. For example, shape fitting such as a least squares method or a Hough transform is used for the application. Then, the line structure identification function 32B identifies an object 50 (object 50₁₀ in FIG. 4) in the object image 60, through which the applied line X3 does not pass (see FIG. 4D).

Next, the line structure identification function 32B calculates a degree of belonging of the object 50 which is located out of the line direction X2, in the line direction X2. The degree of belonging represents a degree of belonging of the object 50 located out of the line direction X2, in the line L extending along the line direction X2. In the present embodiment, the line structure identification function 32B uses an evaluation function inversely proportional to the shortest distance between the line X3 and the object 50 located out of the line direction X2. Then, when the evaluation function is not less than a threshold, the line structure identification function 32B considers that the object 50 belongs to the line direction X2. Therefore, the line structure identification function 32B identifies the objects 50 through which the line X3 representing the line of people passes through, and the objects 50 having a degree of belonging not less than the threshold, as the objects 50 constituting the line L along the line direction X2, in the object image 60.

Then, the line structure identification function 32B identifies an area surrounding the objects 50 identified to constitute the line L, along the line direction X2, as the line area 54 (see FIG. 4E). At this time, the line structure identification function 32B identifies the line area 54 to include all of the objects 50 having a degree of belonging in the line direction X2 not less than the threshold among the objects 50 having been not used for the estimation of the line direction X2. Therefore, in the example of FIGS. 4A to 4F, the line structure identification function 32B identifies the area surrounding the objects 50₁ to 50₉ having directions indicated by the arrows X1₁ to X1₉, as the line area 54 of the line L.

Next, the line structure identification function 328 identifies both ends of the line area 54 in the line direction X2 identified in the object image 60, as the start point position SA and the end point position SB of the line L (see FIG. 4E).

Next, the line structure identification function 32B identifies a periphery of the line area 54 in the object image 60, as the peripheral area 55 (see FIG. 4F). The peripheral area 55 is an area around the line area 54, and not including the objects 50. The peripheral area 55 represents, for example, a range continued (adjacent) to the line area 54, and having a predetermined distance or less from the line area 54, of an area other than the line area 54 and the object areas 52, in the object image 60.

On the basis of the identification of the line area 54, the line structure identification function 32B obtains the shape of the line L, the start point position of the line L, the end point position of the line L, the number of the objects 50 included in the line L, the positions of the objects 50 included in the line L, and the peripheral area of the line L.

That is, the line structure identification function 32B detects the structural information about the line L. That is, line structure identification function 32B identifies the structural information representing the shape of the line L, the number of the objects 50 constituting the line L, the position of each object 50 constituting the line L, the start point position of the line L, the end point position of the line L, the line area of the line L, the peripheral area of the line L, the attribute of each object 50.

Returning to FIG. 1, further description will be given. Here, the line structure identification function 32B uses the object image 60 to identify the structural information. Therefore, the structural information identified by the line structure identification function 32B is represented by positional coordinates in the object image 60.

The corresponding position determination function 32C derives three-dimensional positional coordinates in real space S, corresponding to the positional coordinates indicated by the structural information identified by the line structure identification function 32B. For determination of the three-dimensional positional coordinates, a known method is preferably employed.

That is, the corresponding position determination function 32C converts the structural information identified by the line structure identification function 32B, and represented by two-dimensional coordinates on the object image 60, to the structural information represented by three-dimensional coordinates in real space S.

Therefore, specifically, the corresponding position determination function 32C converts pixels constituting the line area 54 in the object image 60 to the line area 54 expressed by a point group represented by the three-dimensional coordinates in real space S. Note that the line area 54 can also express the shape of the line L.

Furthermore, the corresponding position determination function 32C represents two-dimensional positional coordinates of the objects 50 constituting the line L, included in the structural information, by the three-dimensional positional coordinates in real space S. Furthermore, the corresponding position determination function 32C also represents the start point, position SA and the end point position SB of the line L included in the structural information, by the three-dimensional coordinates in real space S. Similarly, the corresponding position determination function 32C also represents the peripheral area 55 included in the structural information to have pixels constituting the peripheral area 55 in the object image 60, by a point group represented by the three-dimensional coordinates in real space S. Note that since the number of the objects 50 and the attribute of each object 50 included in the structural information cannot be represented by the coordinates, the corresponding position determination function 32C directly uses the number of the objects 50 and the attribute of each object 50 without coordinate transformation.

Then, the identification function 32 outputs the identified structural information (represented by three-dimensional coordinates in real space S) to each of the determination function 33 and the change/update determination function 35.

Next, the determination function 33 will be described. The determination function 33 is an example of a determination unit. The determination function 33 determines the output position of the output information about a situation of the line L, in real space S based on the structural information identified by the identification function 32.

The output information is information about a situation of the line L of the objects 50. The output information may be information showing an output content representing a situation of the line L, or may be information showing an output content according to a situation of the line L. The output information may be a text, an image, or a combination of the text and the image.

The output content shown by the output information includes for example a waiting order, a predicted waiting time, a text expressing a terminal end, or an attractive image. The waiting order represents a position to the first place in the line L. The predicted waiting time represents a predicted value of a time required to be positioned at the first place of the line L. The text expressing a terminal end represents a text or an image expressing a terminal end of the line L. The attractive image represents for example an image expressing a precaution statements to the objects 50 constituting the line L, an advertisement, a game image, a puzzle image, and the like.

That is, the output information is values representing these output contents. Specifically, the output information includes at least one of a value of the waiting order in the line L, a value representing the text expressing a terminal end of the line L, a value representing the predicted waiting time in the line L, and the attractive image.

In the present embodiment, the determination function 33 determines the output position to which the output information is to be output, in an area in real space S which does not overlap the line area 54 based on the structural information received from the identification function 32. Specifically, the determination function 33 determines the output position in the area in real space S which does not overlap the objects 50. In the present embodiment, the determination function 33 determines the output position to which the output information is to be output, in the peripheral area 55 of the line L in real space S.

The output position represents at least one of positional coordinates in the peripheral area 55 in real space S, and a position of the output unit 24 (display) arranged in the peripheral area 55 in real space S. When the output unit 24 is the display, the output position includes identification information for identification of the display arranged in the peripheral area 55 in real space S, and a position (two-dimensional position) in a display screen, of the display.

Note that, in the present embodiment, the output unit 24 is described as the projector. Thus, in the present embodiment, the output position is described to represent the positional coordinates in the peripheral area 55 in real space S.

In the present embodiment, the determination function 33 determines the output position, and the output information to be output to the output position based on the structural information identified by the identification function 32.

Specifically, the determination function 33 includes a selection function 33A, an output information determination function 33B, a position determination function 33C, and a generation function 33D.

The selection function 33A is an example of a selection unit. The selection function 33A selects a display type of the output information. In the display type, the output content about the situation of the line L, and an arrangement rule of the output information representing the output content are at least defined.

The selection function 33A selects one display type from a plurality of the display types prepared in advance. The selection function 33A may select one display type previously determined, or may select a display type specified by an operation instruction from the user to the input unit 26.

Furthermore, the selection function 33A may select one display type based on the structural information about the line L. In this configuration, the selection function 33A previously stores a selection rule that when the structural information about the line L satisfies a certain condition, a display type representing display content is selected. In addition, the selection function 33A preferably uses the selection rule, and the structural information identified by the identification function 32 to select one display type. For example, the display type can be switched between a large number of people in the line and a small number of people in the line. The selection rule can be defined to previously store such a condition that “at least M people in the line”, and a time (10 seconds or the like) in which the switching and presentation is performed so that a display type is selected when the condition is satisfied.

In the present embodiment, the selection function 33A previously stores the display type management DB 40A in the storage circuit 40. The display type management DB 40A is a database for management of the plurality of the display types. Note that data format of the display type management DB 40A is not limited to the database.

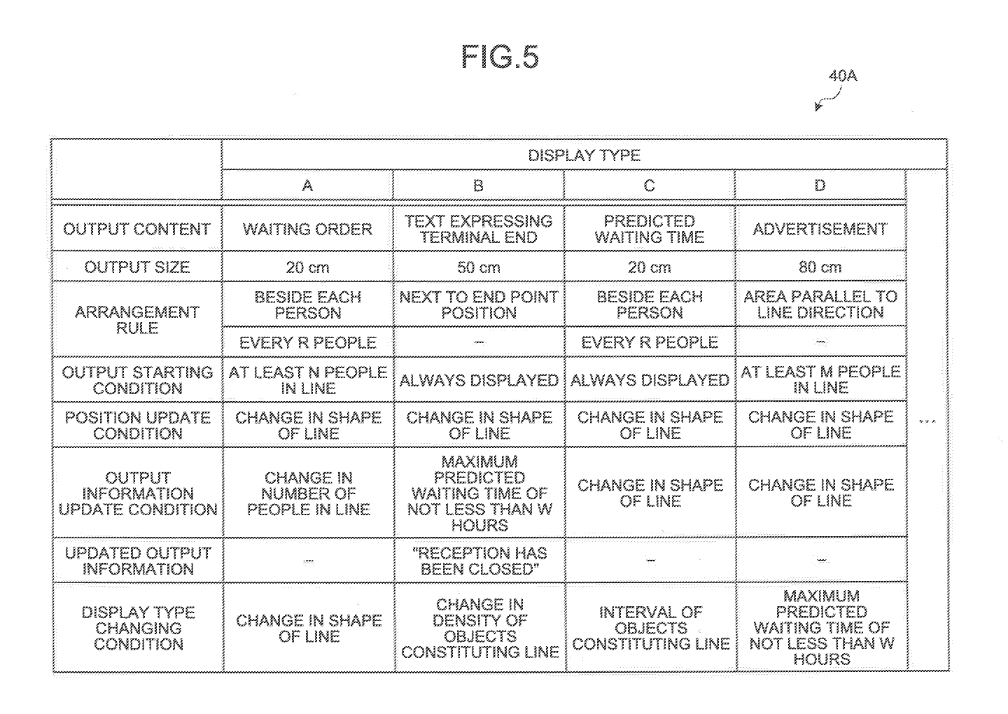

FIG. 5 is a schematic diagram illustrating an example of a data configuration of the display type management DB 40A. In the display type management DB 40A, the plurality of the display types is previously registered.

For example, in the display type management DB 40A, there are defined the output content, an output size, the arrangement rule, an output starting condition, a position update condition, an output information update condition, an updated output content, and a display type update condition, for each display type (display types A to D, in FIG. 5).

The output size represents a size of output information representing corresponding output content, which is output into real space S. The arrangement rule represents an arrangement scheme of the output information, representing corresponding output content. In other words, the arrangement rule represents an arrangement scheme of the output information according to the structural information about the line L. Therefore, the output position of the output information is determined by the arrangement rale defined in the display type, and the structural information about the line L (detailed description will be made later).

The output starting condition represents a condition to start output of the output information representing corresponding output content. The position update condition represents an update condition of an output position of the output information representing corresponding cutout content. The output information update condition represents an update condition of the output information representing corresponding output content. The updated output content represents updated output information when the output information update condition is satisfied. The display type update condition represents an update condition of the display type.

Note that each item and content defined in the display type management DB 40A can be appropriately changed and updated by the operation instruction from the user to the input unit 26, or the like.

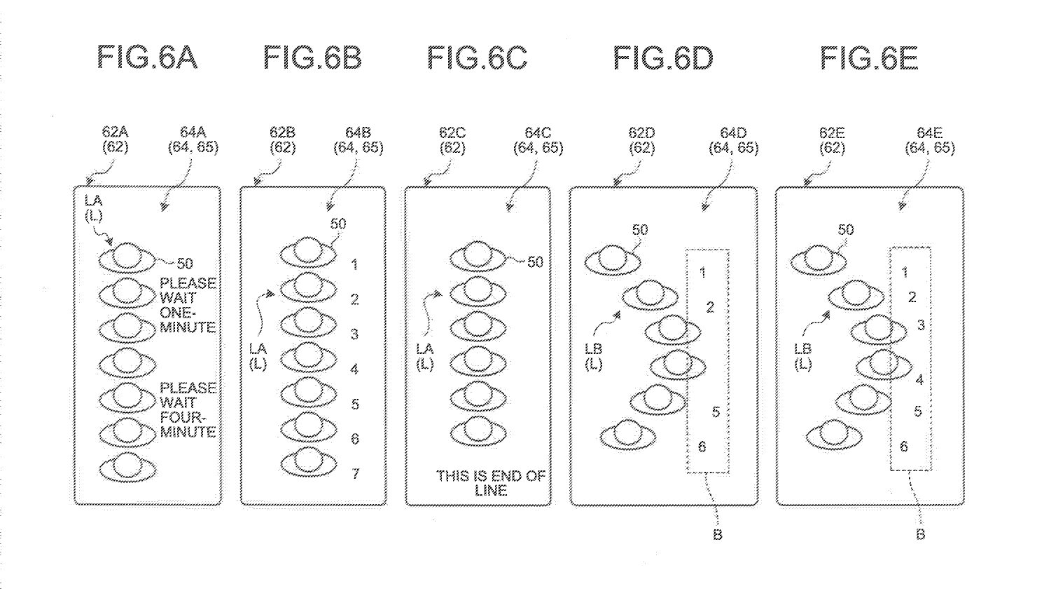

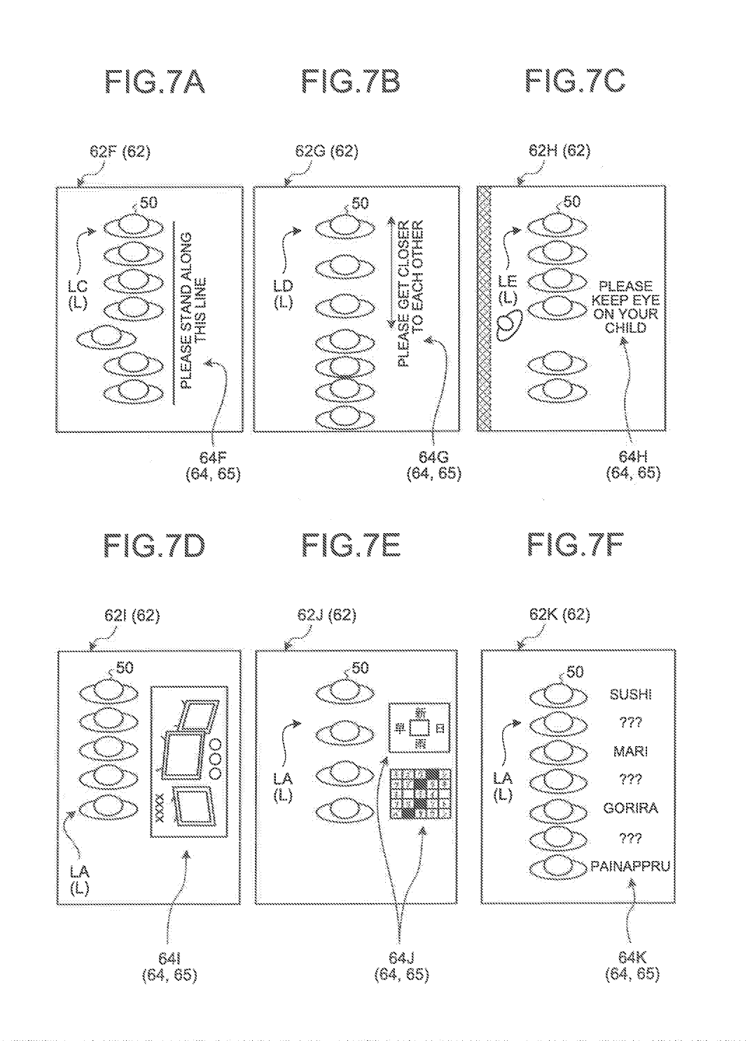

FIGS. 6A to 6E and 7A to 7F are schematic diagrams illustrating examples of the display types 62.

FIG. 6A illustrates a display type 62A in which output information 64A representing a predicted waiting time, such as “Please wait one-minute” or “Please wait four-minute” is output per several objects 50, for a line LA of the objects 50 linearly aligned. FIG. 6B illustrates a display type 62B in which output information 64B representing waiting orders, such as “1” to “7”, of respective objects 50 is output for the line LA of the objects 50 linearly aligned. FIG. 6C illustrates a display type 62C in which output information 64C, “this is end of line” is output into an area next to the end point position SB, for the line LA of the objects 50 linearly aligned.

FIG. 6D illustrates a display type 62D outputting output information 64D representing the waiting orders of the respective objects 50, for a line LB of the objects 50 arcuately lined, and not outputting the output information, for an area out of a projection area B. FIG. 6E illustrates a display type 62B in which output information 64E representing the waiting orders of the respective objects 50 is output into the projection area B, for the line LB of the objects 50 arcuately lined.

FIG. 7A illustrates a display type 62F in which output information 64F representing a caution image expressing a line and a text “please stand along this line” is output beside a line LC of the objects 50 linearly aligned, along the line LC. FIG. 7B illustrates a display type 62G in which output information 64G representing a caution image expressing a line and a text “please get closer to each other” is output along a line LD of the objects 50 linearly aligned, beside an area of the line LD in which the objects 50 have an interval of a predetermined value or more.

FIG. 7C illustrates a display type 62H in which output information 64H representing a caution image expressing a text “please keep eye on your child” is output beside an object 50 in a line LE of the objects 50, positioned nearest to an object 50 separated from the line LE. Note that the object 50 separated from the line LE represents for example an object 50 positioned at a dangerous place exceeding a white line on a train platform.

FIG. 7D illustrates a display type 62I in which output information 64I representing an advertisement is output to the line LA of the objects 50. Note that the output information 64I of FIG. 7D is an example of the output information representing an advertisement of displays. FIG. 7E illustrates a display type 62J in which output information 64J being a puzzle image or a quiz image is output to the line LA of the objects 50. Furthermore, FIG. 7F illustrates a display type 62K in which output information 64K being a game image is output to the line LA of the objects 50.

These display types 62 are preferably pre-registered in the display type management DB 40A. Then, the selection function 33A selects one from the plurality of the display types registered in the display type management DB 40A.

Returning to FIG. 1, further description will be given. The output information determination function 33B is an example of an output information determination unit. The output information determination function 33B determines the output information representing the output content defined in the display type selected by the selection function 33A based on the structural information identified by the identification function 32.

For example, it is assumed that the display type selected by the selection function 33A is the display type A in the display type management DB 40A. In this configuration, the output information determination function 33B determines the output content “waiting order” defined in the display type A, for the output content. In addition, the output information determination function 33B preferably sequentially numbers the respective objects 50 constituting the line L, from the start point position SA based on the structural information to determine the output information representing the waiting order.

Furthermore, it is assumed that the display type selected by the selection function 33A is the display type C in the display type management DE 40A. In this configuration, the output information determination function 33B determines the output content “predicted waiting time” defined in the display type C, for the output content. Then, the output information determination function 33B calculates the predicted waiting time for each of the objects 50 constituting the line L based on the structural information. The output information determination function 33B preferably determines the output information representing the predicted waiting time, in this manner.

Note that, for calculation of the predicted waiting time, a known method is preferably employed. For example, the output information determination function 33B previously stores the predicted waiting times corresponding to the number of the objects 50 constituting the line L. In addition, the output information determination function 33B may read the predicted waiting times corresponding to the number of the objects 50 indicated in the structural information identified by the identification function 32 to calculate the predicted waiting time.

Specifically, the output information determination function 33B may previously set the waiting time per person (e.g., five minutes per person), according to the waiting time per person, and the number or the objects 50 indicated in the structural information to calculate the predicted waiting time. For example, the output information determination function 33B may employ a result of multiplication of the waiting time per person by the number of the objects 50 indicated in the structural information, for the predicted waiting time.

Furthermore, when the line L is formed at a place where curtain time or the like is set, the output information determination function 33B may further use information about the curtain time to calculate the predicted waiting time.

Specifically, it is assumed that current time is 9:30, curtain time is 10:00, the number of the objects 50 constituting the line L is five people, and a waiting time per person is five minutes. In this configuration, the output information determination function 33B preferably performs calculation using a calculation result of “waiting time per person (five minutes)×the number of people (five people)+difference between the current time and the curtain time (thirty minutes)” for the predicted waiting time.

Furthermore, the output information determination, function 33B may extract a specific object 50 from the objects 50 constituting the line L, and use a moving time required for movement of the identified object 50 to a certain distance, and the number of the objects 50 constituting the line L to calculate the predicted waiting time. For this calculation of the predicted waiting time, for example, a method disclosed in JP H11-175694 A is preferably used.

Specifically, at a place of the object 50₁ illustrated in FIG. 3B, information about color of clothes or color of the head, and texture of the object (person) is stored. In addition, a time until the object 50₁ moves away from the place due to start of a service is preferably measured. Furthermore, the output information determination function 33B may measure the time a plurality of times for a defined time to calculate an average waiting time from the measurements. Still furthermore, as an example about another position, the output information determination function 33B may measure a time until a place of the object (person) 50₄ moves to the first place of the line L to predict an average waiting time at the place. Still another furthermore, at a place of the object 50₄, information about color of clothes or color of the head, and texture of the person is stored, and a time at the storage is defined as T1. A time until the same information about texture and color appears at the place of the object 50₁ is defined as T2. In addition, the output information determination function 33B preferably uses the moving time T2−T1 as the waiting time at the place of the object 50₄.

In addition, the output information determination function 33B may calculate the predicted waiting time, from the structural information about the line L, using another method.

The position determination function 33C determines the output position of the output information based on the structural information identified by the identification function 32. The position determination function 33C determines the output position of the output information, to a position in real space S which does not overlap the line LA, around the line LA. In other words, the position determination function 33C determines the output position of the output information, in the peripheral area 55 of the line L in real space S, included in the structural information identified by the identification function 32.

In the present embodiment, the position determination function 33C determines a position in real space S determined by the structural information identified by the identification function 32, and the arrangement rule defined in the display type selected by the selection function 33A, for the output position of the output information. That is, the position determination function 33C determines, for the output position, a position in the peripheral area 55 in real space S, indicated, by the arrangement rule defined in the display type selected by the selection function 33A.

Therefore, for example, when the display type A is selected from the display type management DB 40A, the position determination function 33C determines, for the output position, positions in the peripheral area 55 of the line L, beside the objects 50 constituting the line L, every R people (R is an integer of 1 or more).

Next, the generation function 33D will be described. The generation function 33D generates a screen for outputting the output information determined by the output information determination function 33B to the output position in real space S determined, by the position determination function 33C.

Note that when the processing circuit 30 controls the projector as the output unit 24, the generation function 33D generates a projection screen as the screen.

When the projection screen is generated, the generation function 33D generates the projection screen for outputting the output information to the output position in real space S. Specifically, the generation function 33D generates the projection screen so that the output information determined by the output information determination function 33B, having an output size defined in the display type selected by the selection function 33A is output to the output position determined by the position determination function 33C.

Next, the output control function 34 will be described. The output control function 34 is an example of an output control unit. The output control function 34 outputs the output information to the output position. The output control function 34 controls the output unit 24 to output the output information to the output position.

That is, the output control function 34 controls the output unit 24 so that the output information determined by the determination function 33 is output to the output position determined on the basis of the structural information by the determination function 33.

Specifically, the output control function 34 controls the output unit 24 to output the screen (projection screen) generated by the generation function 33D of the determination function 33. As described above, in the present embodiment, the output unit 24 is described as the projector.

Thus, the output control function 34 controls the output unit 24 to project the projection screen. Thus, in the peripheral, area 35 of the objects 50 constituting the line L in real space S, the output information according to the structural information about the line L is output to the output position according to the structural information about the line L.

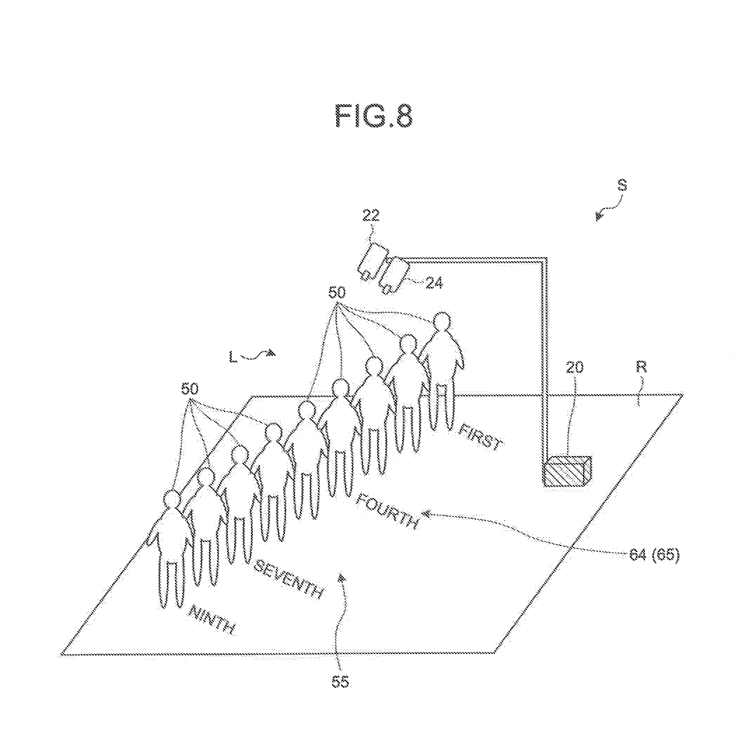

FIG. 8 is a schematic diagram illustrating an example of the output information 64 projected in real space S. For example, the projection, screen 65 is projected from the output unit 24 by the control from the output control function 34, and the output information 64 representing the waiting order or the like is output into the peripheral area 55 of the objects 50 forming the line L. Thus, the information according to the situation of the line L is appropriately provided for the objects 50 constituting the line L.

Returning to FIG. 1, further description will be given. Next, the change/update determination function 35 and the update function 36 will be described.

After the output information is output, the change/update determination function 35 determines update or change of at least one of the output information, the output content, and the display type. The update function 36 updates or changes at least one of the output information, the output content, and the display type, according to the result of determination by the change/update determination function 35.

In the present embodiment, the change/update determination function 35 includes a first change/update determination function 35A, a second change/update determination function 35B, and a third change/update determination function 35C. The update function 36 includes a position update function 36A, an output information update function 36B, and a type changing function 36C.

The first change/update determination function 35A is an example of a first change/update determination unit. The position update function 36A is an example of a position update unit.

The first change/update determination function 35A determines whether the position update condition of the output position is satisfied. The position update condition represents a condition to update the output position of the output information having been output. The position update condition defines for example change in shape of the line L, change in the number of the objects 50 constituting the line L, a maximum predicted waiting time of the objects 50 constituting the line L of W hours or more, or change in interval or density of the objects 50 constituting the line L. Note that W is a number more than 0. The position update condition is preferably set in advance. In the present embodiment, the first change/update determination function 35A determines whether the “position update condition”, which is defined in the display type selected by the selection function 33A, is satisfied.

For example, it is assumed that the display type selected by the selection function 33A is the display type A in the display type management DB 40A. In this configuration, when determining the position update condition “change in shape of the line” which is defined in the display type A, the first change/update determination function 35A preferably determines that the position update condition is satisfied. The first change/update determination function 35A preferably determines the change in shape of the line based on the shape of the line area 54 represented in the structural information identified by the identification function 32.

When the first change/update determination function 35A determines that the position update condition is satisfied, the position update function 36A updates the output position. The position update function 36A preferably uses the structural information used for determination by the first change/update determination function 35A to update the output position so that the output position is located at a position in the peripheral area 55 of the line L, satisfying the arrangement rule defined in the display type selected by the selection function 33A.

The position update function 36A preferably uses new structural information to update the output position, in a similar manner to the position determination function 33C of the determination function 33. Note that the position update function 36A may output an output position update instruction to the determination function 33 to update the output position. In this configuration, the position determination function 33C of the determination function 33 preferably uses newly identified structural information to determine the output position, similarly to the above description. The position update function 36A may update the output position, in this manner.

The second change/update determination function 35B is an example of a second change/update determination unit. The output information update function 36B is an example of an output information update unit.

The second change/update determination function 35B determines whether the cutout information update condition of the output information is satisfied. The output information update condition represents a condition to update the output information having been output. The output information update condition includes for example change in the number of the objects 50 constituting the line L, a maximum, predicted waiting time of the objects 50 constituting the line L of not less than W hours, change in shape of the line L, or change in interval or density of the objects 50 constituting the line L. Note that W is a number more than 0. The output information update condition is preferably set in advance. In the present embodiment, the second change/update determination function 35B determines whether the “output information update condition”, which is defined in the display type selected by the selection function 33A, is satisfied.

For example, it is assumed that the display type selected by the selection function 33A is the display type A in the display type management DB 40A. In this configuration, when determining the output information update condition “change in the number of people in the line” defined in the display type A, the second, change/update determination function 35B preferably determines that the output information update condition is satisfied. The second change/update determination function 35B preferably determines the change in the number of people in the line L depending on the number of the objects 50 constituting the line L represented in the structural information identified by the identification function 32.

When the second change/update determination function 35B determines that the output information update condition is satisfied, the output information update function 36B updates the output information. The output information update function 36B preferably uses the structural information used for determination by the second change/update determination function 35B to determine new output information.

The output information update function 36B preferably uses new structural information to update the output information, in a similar manner to the output information determination function 33B of the determination function 33. Note that the output information update function 36B may output an output information update instruction to the determination function 33 to update the output, information. In this configuration, the output information determination function 33B of the determination function 33 preferably uses newly identified structural information to determine the output information, similarly to the above description. The output, information update function 36B may update the output, information, in this manner.

Note that when the line L is constituted to some extent from an initial state in which nothing is displayed, the output information update function 36B may update the output information to start display of the waiting time.

The third change/update determination function 35C is an example of a third change/update determination unit. The type changing function 36C is an example of a type changing unit.

The third change/update determination function 350 determines whether a type changing condition of the display type of the output information is satisfied. The type changing condition is a condition to change a display type having been output. The type changing condition includes for example a change in the number of the objects 50 constituting the line L, a maximum, predicted waiting time of the objects 50 constituting the line L of not less than W hours, a change in shape of the line L, or a change in interval or density of the objects 50 constituting the line L. Note that W is a number more than 0. The type changing condition is preferably see in advance. In the present embodiment, the third change/update determination function 35C determines whether the “type changing condition”, which is defined in the display type selected by the selection function 33A, is satisfied.

For example, it is assumed that the display type selected by the selection function 33A is the display type A in the display type management DB 40A. In this configuration, when determining the type changing condition “change in shape of the line” defined in the display type A, the third change/update determination function 35C preferably determines that the type changing condition is satisfied. The third change/update determination function 35C preferably determines the change in shape of the line L depending on the shape of the line L represented, in the structural information identified by the identification function 32.

When the third change/update determination function 35C determines that the type changing condition is satisfied, the type changing function 36C changes the display type. The type changing function 36C preferably uses the structural information used for determination by the third change/update determination function 36C to determine a new display type.

The type changing function 36C preferably uses new structural information to update the display type, in a similar manner to the selection function 33A of the determination function 33. Note that the type changing function 36C may output, a display type change instruction to the determination, function 33 to change the display type. For example, in this configuration, the selection function 33A of the determination function 33 preferably selects a new display type different from the last selected display type. The type changing function 36C may change the display type, in this manner.

In addition, the generation function 33D of the determination function 33 preferably uses the changed display type, the updated output position, or the updated cutout information to generate the projection screen output to the output unit 24, similarly to the above description. In addition, the output control function 34 preferably controls the output unit 24 to project the updated of changed projection screen.

Thus, when the change/update determination function 35 determines that the update condition or changing condition is satisfied, the projection screen 65 projected into real space S is updated or changed. Note that the update function 36 preferably updates or changes at least one of the output position, the output information, and the display type, and is not limited to a mode updating or changing only one of them.

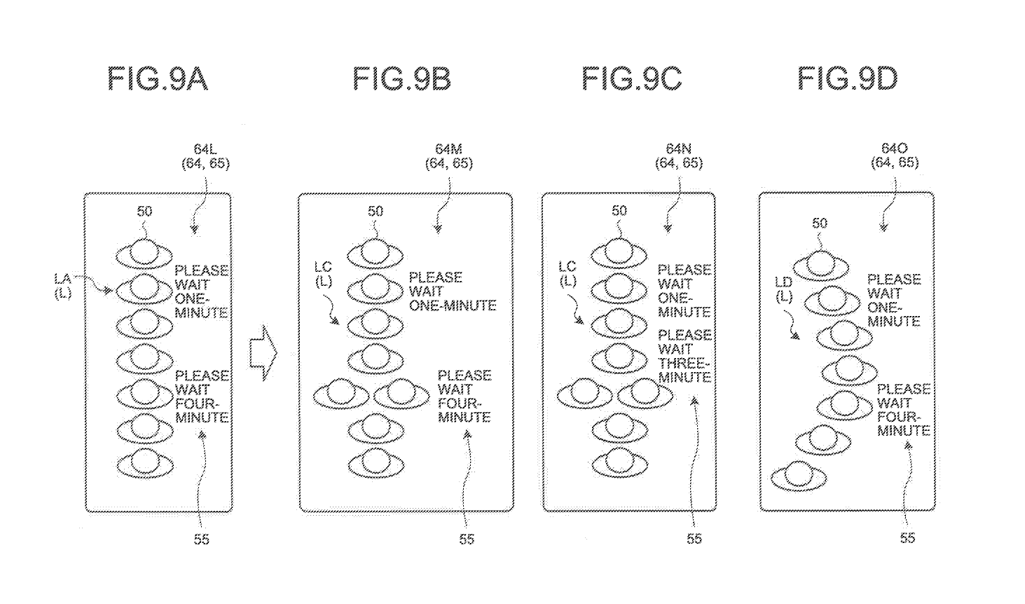

FIGS. 9A to 9D are schematic diagrams illustrating examples of update or change of the projection screen 65. For example, it is assumed that the output control function 34 projects the projection screen 65 illustrated in FIG. 9A, into the peripheral area 55 of the line L. Then, it is assumed that the line L is changed for example to the line LC having a shape illustrated in FIGS. 9B or 9C, or the line LD having a shape illustrated in FIG. 9D.

For example, in this configuration, the output position of the output information is updated by the position update function 36A, and the output position of the output information “Please wait four-minute” included in output information 64L illustrated in FIG. 9A is updated to be located at a position along the changed shape of the line LC (see FIG. 9B, output information 64M). That is, the output position in the output information 64L is updated to be located at an output position which does not overlap the objects 50 constituting the line L, according to the change in shape of the line L.

Furthermore, for example, when the output information is updated by the output information update function 36B, the output information “Please wait four-minute” included in the output information 64L illustrated in FIG. 9A is changed to the output information “Please wait three-minute” representing the predicted waiting time corresponding to an object 50 located in front of the position, and the output position is also updated to be located beside the object 50 (see FIG. 9C, output information 64N).

Furthermore, for example, the output position of the output information is updated by the position update function 36A, and the output positions of the output information “Please wait one-minute” and “Please wait four-minute” included in the output information 64L illustrated in FIG. 9A are updated to be located at positions (see FIG. 9D, output information 640) along the changed line LD. That is, the output position in the output information 64L is updated to be located at an output position which does not overlap the objects 50 constituting the line L, according to the change in shape of the line L.

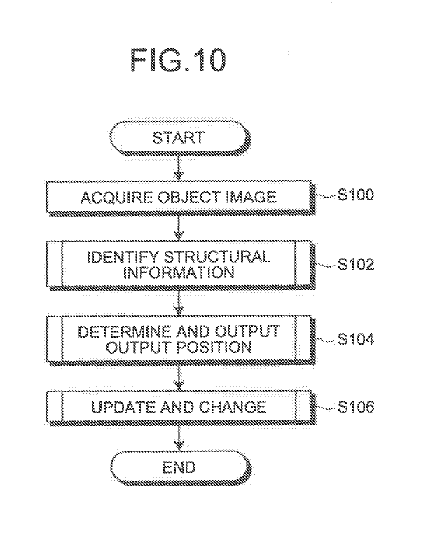

Next, an example of a procedure of information processing performed by the processing circuit 30 will be described. FIG. 10 is a flowchart illustrating the example of the procedure of information processing performed by the processing circuit 30.

The acquisition function 31 of the processing circuit 30 starts to acquire the object image 60 (step S100). Next, the identification function 32 performs structural information identification processing (step S102). Next, the determination function 33 and the output control function 34 perform determination processing and output processing for the output position, respectively (step S104). Next, the update function 36 performs update and change processing (step S106). Then, the present routine ends.

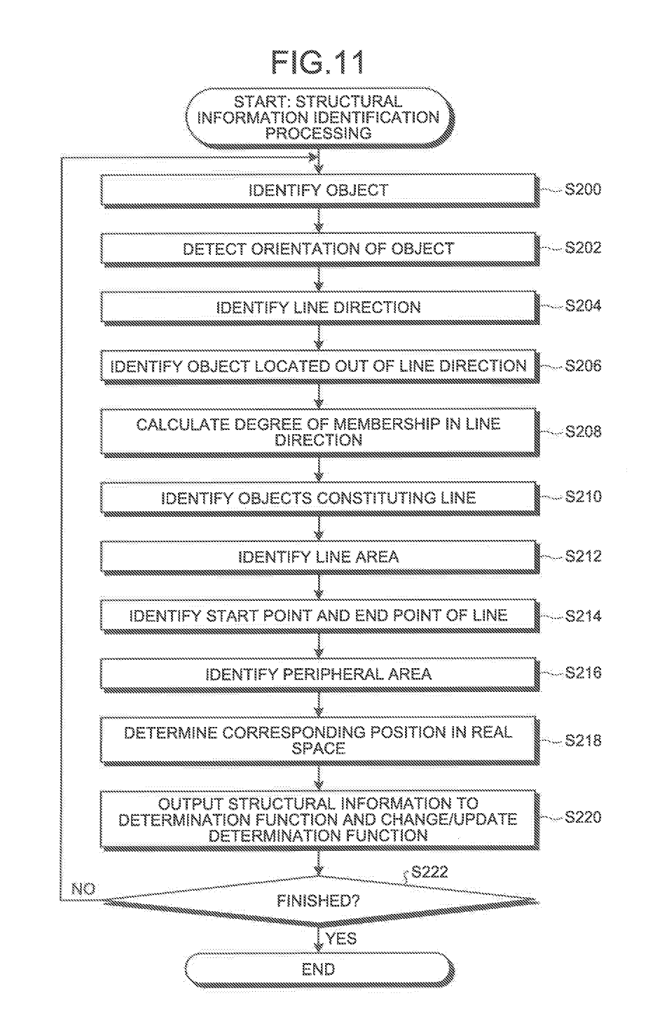

Next, an example of a procedure of structural-information identification processing of step S102 (see FIG. 10) will be described. FIG. 11 is a flowchart illustrating the example of the procedure of structural information identification processing.

First of all, the detection function 32A of the identification function 32 identifies an object 50 included in the object image 60 acquired by the acquisition function 31 (step S200). Next, the detection function 32A detects the direction of the identified object 50 (step S202). Then, the line structure identification function 32B identifies the line direction X2 of the line L of the objects 50 (step S204).

Next, the line structure identification function 32B identifies an object 50 located out of the identified line direction X2 of the objects 50 included, in the object image 60 (step S206). Then, the line structure identification function 32B calculates the degree of belonging of the object 50 which is located out of the line direction X2, in the line direction X2 (step S208).

Next, the line structure identification function 32B identifies the objects 50 constituting the Line L (step S210). Then, the line structure identification function 32B identifies the line area 54 of the line L (step S212). Then, the line structure identification, function 32B identifies both ends of the line area 54 in the line direction X2, as the start point, position SA and the end point position SB of the line L (step 3214).

Next, the line structure identification function 32B identifies the periphery of the line area 54 in the object image 60, as the peripheral area 55 (step S216).

Next, the corresponding position determination function 32C derives the three-dimensional positional coordinates in real space S, corresponding to the positional coordinates indicated by the structural information identified by the line structure identification function 32B (step S218).

Next, the corresponding position determination function 32C outputs the structural information represented by the three-dimensional coordinates in real space S to the determination, function 33 and the change/update determination function 35 (step S220).

Next, the identification function 32 determines whether to finish the processing (step S222). For example, the identification function 32 determines whether an instruction signal representing the finish of the processing is input on the basis of the operation instruction from the user to the input unit 26, and the determination is made in step S222.

When a negative determination is made in step S222 (step S222: No), the processing returns to step S200. Thus, the identification function 32 performs processing of steps S200 to S222, each time the acquisition function 31 acquires a new object, image 60. When, an affirmative determination is made in step S222 (step S222: Yes), the present, routine ends. Note that in the flowchart in FIG. 11, for example steps S202 to S216 are not necessarily required to be performed in this order.

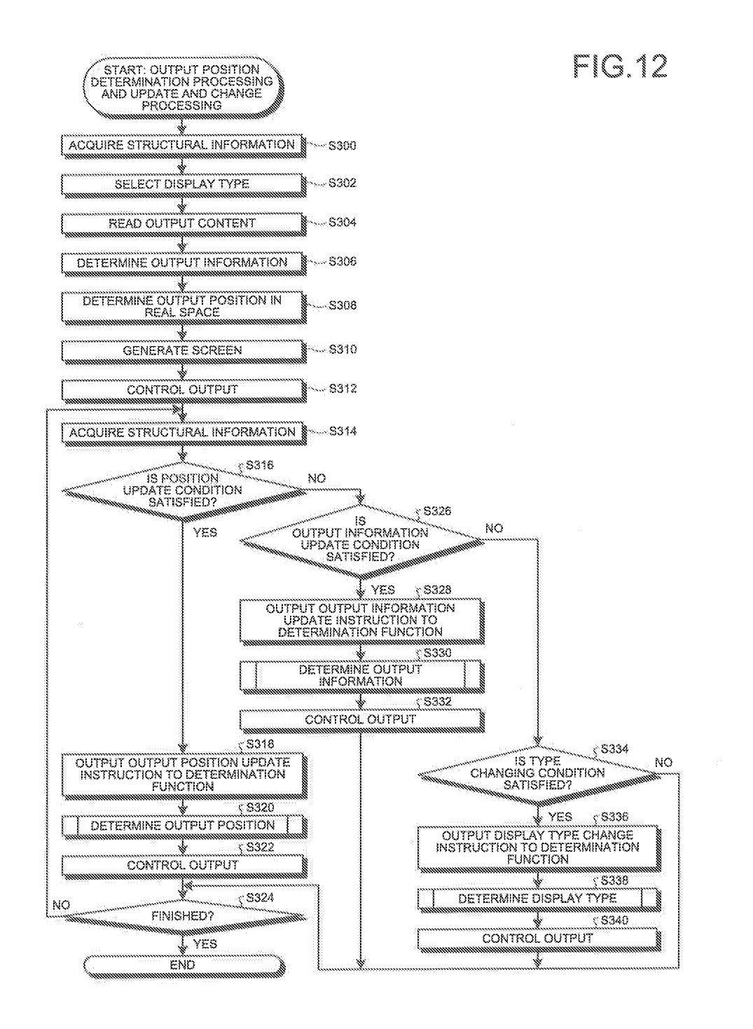

Next, output position determination and output processing (step S104) and update and change processing (step S106) in FIG. 10 will be described in detail. FIG. 12 is a flowchart illustrating an example of a procedure of the output position determination and output processing and the update and change processing performed by the output control function 34, the change/update determination function 35, and the update function 36.

First of all, the determination function 33 acquires the structural information from the identification function 32 (step S300). Next, the selection function 33A of the determination function 33 selects a display type (step S302).

Next, the output information determination function 33B reads the output content, defined in the display type selected in step S302, from the display type management DB 40A (step S304). Next, the output information determination function 33B determines the output information representing the output content read in step S304 based on the structural information acquired in step S300 (step S306).

Next, the position determination function 33C determines the output position in real space S of the output information determined in step S306 based on the structural information acquired in step S300 (step S308).

Next, the generation function 33D generates a screen for outputting the output information determined by the output information determination function 33B to the output position determined in step S308, in real space S (step S310).

Next, the output control function 34 controls the output unit 24 to output the screen (e.g., projection screen) generated in step S310 (step S312). Thus, the output information according to the situation of the line L is output to the output position in the peripheral area 55 of the line L in real space S.

Next, the change/update determination function 35 acquires the structural information from the identification function 32 (step S314).

Next, the first change/update determination function 35A determines whether the position update condition of the output position is satisfied depending on the structural information acquired in step S314 (step S316). When an affirmative determination is made in step S31S (step S316: Yes), the process proceeds to step S318. In step S318, the position update function 36A outputs the output position update instruction to the determination function 33 (step 3318).

The position determination function 33C of the determination function 33 uses the structural information acquired in step S314 to determine the output position, similarly to the above description (step S320). Then, the determination function 33 uses the newly determined output position to perform the processing similar to that in the above description, and generates the projection screen output to the output unit 24. Thus, the position update function 36A updates the output position, in this manner.

Then, the output control function 34 controls the output unit 24 to output the projection screen in which the output position is updated (step S322). Then, the process proceeds to step S324.

In step S324, the processing circuit 30 determines whether to finish the information processing (step S324). For example, the processing circuit 30 determines whether a signal representing the finish of the information processing is received depending on for example the operation instruction from the user to the input unit 26, and determination is made in step S324. When a negative determination is made in step S324 (step S324: No), the process returns to step S314. When an affirmative determination is made in step S324 (step S324: Yes)f the present routine ends.

On the other hand, when a negative determination is made in step S316 (step S316; No), the process proceeds to step S326. In step S326, the second change/update determination function 35B determines whether the output information update condition of the output information is satisfied depending on the structural information acquired in step S314 (step S326). When an affirmative determination is made in step S326 (step S326; Yes), the process proceeds to step S32B.

In step S328, the output, information update function 36B outputs the output information update instruction to the determination function 33 (step S328). The output information determination function 33B of the determination function 33 uses the structural information acquired in step S314 to determine the output information, similarly to the above description (step S330). Then, the determination function 33 uses the newly determined output information to perform the processing similar to that in the above description, and generates the projection screen output to the output unit 24. The output information update function 36B updates the output information, in this manner.

Then, the output control function 34 controls the output unit 24 to output the projection screen in which the output information is updated (step S332). Then, the process proceeds to step S324.

On the other hand, when a negative determination is made in step S326 (step S326; No), the process proceeds to step S334. In step S334, the third change/update determination function 35C determines whether the type changing condition of the display type is satisfied depending on the structural information acquired in step S314 (step S334). When an affirmative determination is made in step S334 (step S334: Yes), the process proceeds to step S336.

In step S336, the type changing function 36C outputs the display type change instruction to the determination function 33 (step S336). The selection function 33A of the determination function 33 determines a new display type (step S338). Then, the determination function 33 uses the newly determined display type to perform the processing similar to that in the above description, and generates the projection screen output to the output unit 24. The type changing function 36C changes the display type, in this manner.

Then, the output control function 34 controls the output unit 24 to output the projection screen in which the display type is updated (step S340). Then, the process proceeds to step S324. Note that when a negative determination is made in step S334 (step S334; No), the process proceeds to step S324. Note that in the flowchart in FIG. 12, for example steps S316 to S340 are not necessarily required, to be performed in this order.

As described above, the information processing device 20 according to the present embodiment includes the determination function 33 and the output control function 34. The determination function 33 determines the output, position in real space S of the output information about a situation of the line L based on the structural information representing the structure of the line L of the objects 50 included in the object image 60. The output control function 34 controls output of the output information to the output position.

As described above, the information processing device 20 according to the present embodiment determines the output position in real space S of the output information about a situation of the line L based on the structural information representing the structure of the line L. Thus, in the information processing device 20 according to the present embodiment, the output information about a situation of the line L can be output not to a fixed position, but to the output position according to the structural information about the line L.

Therefore, as illustrated in FIG. 8, the projection screen 65 including the output information 64 is projected, in the peripheral area 55 of the line L on a road surface R, in real space S. Thus, the objects 50 constituting the line n can visually confirm the output information 64 projected on the road, surface R to recognize the output information about a situation of the line L, such as a waiting time or order, without confirming their positions in the line L by themselves.

Accordingly, the information processing device 20 according to the present embodiment can appropriately provide the information according to the situation of the line L.

Note that, FIG. 8 illustrates the road surface R on which the output information 64 is projected. However, the output position of the output information 64 is not limited to the road surface R. For example, the output control function 34 may project the projection screen 65 on a wall of a building or fence near the line L.

Note that, in the present embodiment, the output unit 24 has been described as the projector. However, the output unit 24 may at least partially has a display. When the output unit 24 at least partially has the display, the output position preferably includes the identification information for identification of the display arranged in the peripheral area 55 in real space S, and the position (two-dimensional position) in the display screen of the display.

In addition, the generation function 33D preferably generates the display screen as the screen. Furthermore, when the processing circuit 30 controls the projector as the output unit 24 and the display, the generation function 33D preferably generates the projection screen and the display screen.

When the display screen is generated, the generation function 33D generates the display screen for outputting the output information to the output position in real space 3. Specifically, the generation function 33D preferably generates the display screen so that the output information determined by the output information determination function 33B, having an output size defined in the display type selected by the selection function 33A is output to the output position determined by the position determination function 33C. Note that the output position preferably is a position corresponding to the output position in the output unit 24 (display) arranged at the output position determined by the position determination function 33C, or on a display surface of the display.

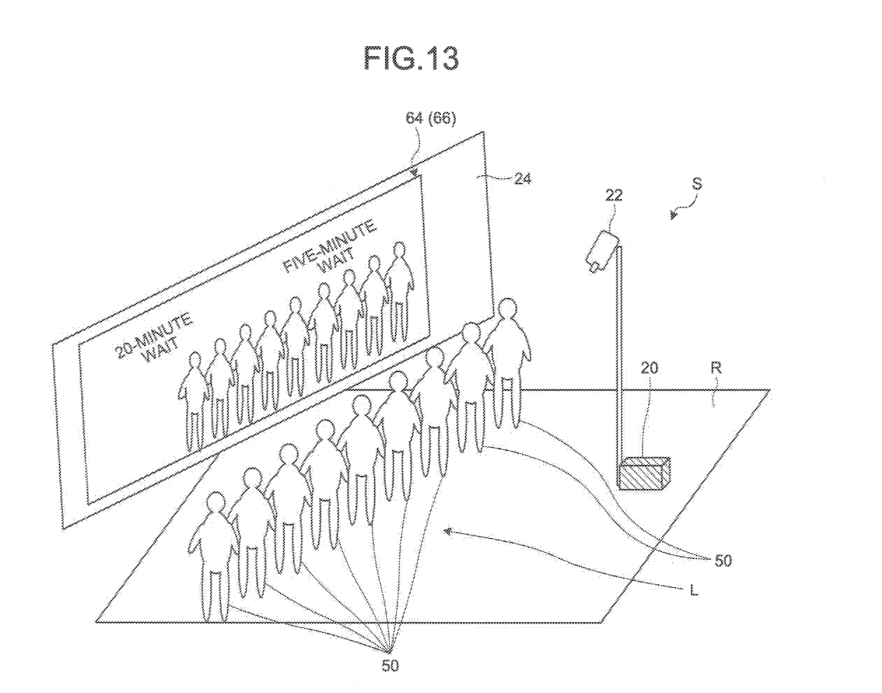

In addition, the output control function 34 preferably controls the output unit 24 to display the display screen generated by the determination function 33. FIG. 13 is a schematic diagram, illustrating a state in which the display screen 66 is displayed on the display as the output unit 24 arranged in real space S. As illustrated in FIG. 13, the output control function 34 may display the display screen 66, on the display as the output unit 24 arranged in real space S.

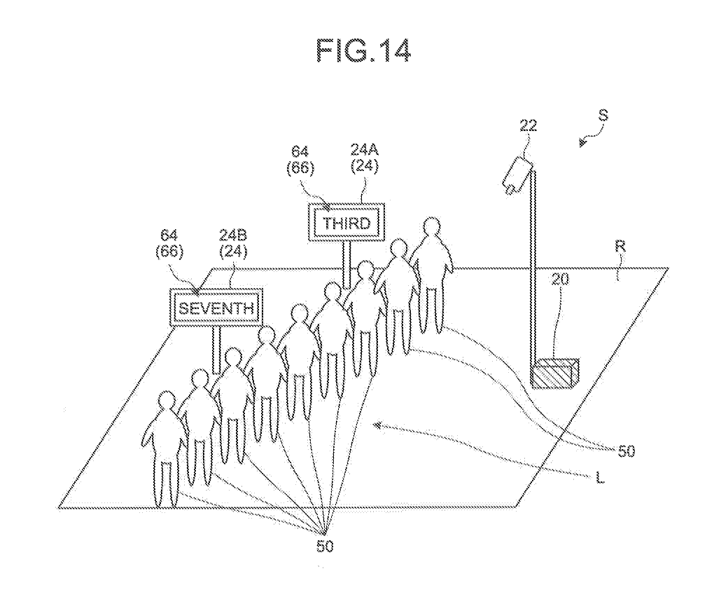

Furthermore, the output control function 34 may display the display screen on each of a plurality of the output units 24 located in real space S. FIG. 14 is a schematic diagram illustrating an environment in which a plurality of the displays, as the output units 24, is arranged in real space S. In this configuration, the output control function 34 preferably controls the output units 24 (output units 24A and 24B) to output corresponding output information, The output units 24 correspond to the output positions in real space S, which are determined by the determination function 33.

Furthermore, the output control function 34 preferably controls a display of a terminal device, onto which an application for displaying a display screen generated by the processing circuit 30 is installed, to display the generated display screen. In this configuration, the output control function 34 preferably transmits the generated display screen to the terminal device onto which the application is installed. Therefore, for example, the display screen generated by the information processing device 20 and including the output, information is displayed on a terminal device, which is located at a position according to the output position determined by the determination function 33, of the terminal devices of the users, in this manner.

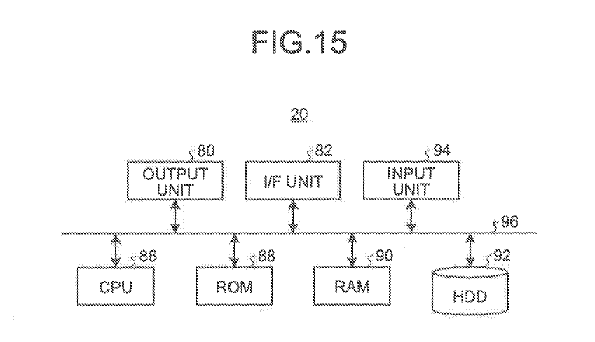

Next, an example of a hardware configuration of the information processing device 20 according to the above embodiment will be described. FIG. 15 is an example of a diagram illustrating the hardware configuration of the information processing device 20 according to the above embodiment.

The information processing device 20 according to the above embodiment includes a control device such, as a central processing unit (CPU) 86, a storage device such as a read only memory (ROM) 88, a random access memory (RAM) 90, and a hard, disk drive (HDD) 92, an I/F unit 82 serving as an interface with various devices, an output unit 80 configured to output various information such as output information, an input unit 94 configured to receive user's operation, and a control bus 96 configured to connect each unit, and the information processing device 20 has a hardware configuration using a normal computer.

In the information processing device 20 according to the above embodiment, the CPU 86 reads a program from the ROM 88 to execute the program on the RAM 90, and each of the functions described above is achieved on the computer.

Note that the programs executing above-mentioned processing performed in the information processing device 20 according to the above embodiment, may be stored in the HDD 92. Furthermore, the programs executing the above-mentioned processing performed in the information processing device 20 according to the above embodiment may be provided by being incorporated into the ROM 88 beforehand.

Furthermore, the programs executing the above-mentioned processing performed in the information processing device 20 according to the above embodiment may be stored in a computer-readable storage medium, such as a CD-ROM, a CD-R, a memory card, a digital versatile disk (DVD), or a flexible disk (FD) in an installable or executable format, and provided as a computer program product. Furthermore, the programs executing the above-mentioned processing performed in the information processing device 20 according to the above embodiment, may be stored on a computer connected to a network such as the Internet, and provided by being downloaded via the network. Furthermore, the programs executing the above-mentioned processing performed in the information processing device 20 according to the above embodiment may be provided or distributed via the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form, of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and processing circuitry configured to operate as;
a determination unit configured to determine an output position of output information about a state of a line, in real space, on the basis of structural information representing a structure of the line formed by objects included in an object image; and
an output control unit configured to control output of the output information to the output position.

2. The information processing device according to claim 1, further comprising
an identification unit configured to identify the structural information of the line according to the object image,
wherein the determination unit determines the output position based on the identified structural information.

3. The information processing device according to claim 1, wherein
the determination unit
determines the output position in a peripheral area of the objects in real space based on the structural information.

4. The information processing device according to claim 3, wherein
the output position represents at least one of positional coordinates in the peripheral area in real space, and a position of a display unit arranged in the peripheral area in real space.

5. The information processing device according to claim 1, wherein
the determination unit
determines the output position, and the output information to be output to the output position based on the structural information.

6. The information processing device according to claim 1, wherein
the determination unit includes:
a selection unit configured to select a display type in which an output content about a situationsituation of the line, and an arrangement rule of output information representing the output content are at least defined;
an output information determination unit configured to determine the output information representing the output content defined in the selected display type; and
a position determination unit configured to determine a position in real space determined by the structural information, and the arrangement rule defined in the selected display type, for the output position.

7. The information processing device according to claim 1, wherein
the determination unit includes
a generation unit configured to generate a projection screen outputting the output information to the output position in real space, and
the output control unit
controls an output unit to project the projection screen to a position according to the output position in real space.

8. The information processing device according to claim 1, wherein
the determination unit includes
a generation unit configured to generate a display screen outputting the output information to the output position in real space, and
the output control unit
displays the display screen on a display unit arranged at a position according to the output position in real space.

9. The information processing device according to claim 1, wherein
the output information includes at least one of a value of a waiting order in the line, a value on a position representing a terminal end of the line, a value representing a predicted waiting time in the line, and advertisement information.

10. The information processing device according to claim 1, further comprising:
a first change/update determination unit configured to determine whether a position update condition of the output position is satisfied; and
a position update unit configured to update the output position, when the position update condition is satisfied.

11. The information processing device according to claim 1, further comprising:
a second change/update determination unit configured to determine whether an output information update condition of the output information is satisfied; and
an output, information update unit configured to update the output information, when the output information update condition is satisfied.

12. The information processing device according to claim 6, further comprising:
a third change/update determination unit configured to determine whether a type changing condition of display type of the output information is satisfied; and
a type changing unit configured to change the display type, when the type changing condition is satisfied.

13. The information processing device according to claim 1, wherein
the structural information represents at least one of a shape of the line, a start point position of the line, and an end point position of the line.

14. The information processing device according to claim 1, further comprising an image capturing unit configured to acquire the object image.

15. The information processing device according to claim 1, further comprising an output unit configured to output the output information.

16. The information processing device according to claim 15, wherein, the output unit is a projector or a display.

17. An information processing method comprising:
determining an output position of output information about a state of a line, in real space, on the basis of structural information representing a structure of the line formed by objects included in an object image; and
controlling output of the output information to the output position.

18. The information processing method according to claim 17, further comprising
identifying the structural information of the line according to the object image,
determining the output position based on the identified structural information.

19. The information processing method according to claim 17, wherein
determining the output position in a peripheral area of the objects in real space based on the structural information.

20. A computer program product having a non-transitory computer readable medium including an information processing program, wherein the program, when executed by a computer, causes the computer to perform;
determining an output position of output information about a state of a line, in real space, on the basis of structural information representing a structure of the line formed by objects included in an object image; and
controlling output of the output information to the output position.
